(19) United States
(12) Patent Application Publication
(10) Pub. No.: US 2026/0135590 A1
(43) Pub. Date: May 14, 2026

(54) RECONFIGURABLE INTELLIGENT SURFACE AND CONTROL THEREOF

(71) Applicant: Telefonaktiebolaget LM Ericsson (publ), Stockholm (SE)

(72) Inventors: Rickard LJUNG, Helsingborg (SE); Henrik SJÖLAND, Lund (SE); Mojtaba MAHDAVI, Lund (SE); Shousheng HE, Södra Sandby (SE); Magnus OLSSON, Klagshamn (SE)

(21) Appl. No.: 19/121,339

(22) PCT Filed: Oct. 28, 2022
(86) PCT No.: PCT/EP2022/080226

§ 371 Date: Apr. 15, 2025

(51) Int. Cl. H04B 7/04

(52) U.S. Cl. CPC H04B 7/04013

(57) ABSTRACT

There is provided a reconfigurable intelligent surface. The reconfigurable intelligent surface includes antenna elements provided in a reflective array. Each antenna element has a controllable reflection phase. Only a strict subset of the antenna elements is arranged for obtaining radio measurements. The antenna elements of the strict subset are distributed across the reflective array. The reconfigurable intelligent surface includes a controller. The controller is configured to evaluate radio signal characteristics of the reflective array from the radio measurements. The controller is configured to control the reflection phases of the antenna elements as a function of the evaluated radio signal characteristics.

### TECHNICAL FIELD

Embodiments presented herein relate to a reconfigurable intelligent surface. Further embodiments presented herein relate to a method, a controller, a computer program, and a computer program product for controlling the reconfigurable intelligent surface.

### BACKGROUND

Reconfigurable intelligent surfaces (RISs) offer an opportunity for improved wireless communication. Specifically, significant gains are envisioned to be made for millimeter wave spectrum, which is the spectrum used in fifth generation and sixth generation telecommunication systems. This spectrum has serious challenges when it comes to propagation and coverage, e.g., due to its support for very high frequency ranges in tens of GHz. The challenges are larger compared to challenges for spectrum with lower frequencies e.g., for so-called sub-6 GHz frequency bands.

Usage of RIS can vary, but in general an RIS can be configured to reflect wireless signals in a controlled manner, e.g., to steer transmitted signals in a certain direction. This could for example be used to improve overall system coverage, range, and efficiency. RISs are commonly also referred to as large intelligent surfaces, smart reflect-arrays, intelligent reflecting surfaces, passive intelligent mirrors, artificial radio space, and meta-surfaces.

In short, the RIS at its surface comprises an antenna array having multiple (e.g., hundreds or thousands) of antenna elements, or just elements for short. Each element can be individually configured, or controlled, to dynamically adjust the reflecting properties of the surface. The elements are provided rather to modify the properties of a signal by its reflection. The RIS commonly comprises a controller that is configured to transmit control signals to tune the properties of each element in the RIS. One example of this is disclosed in A. Araghi et al., “Reconfigurable Intelligent Surface (RIS) in the Sub-6 GHz Band: Design, Implementation, and Real-World Demonstration,” in IEEE Access, vol. 10, pp. 2646-2655, 2022, doi: 10.1109/ACCESS.2022.3140278. The RIS is thus not transmitting or receiving signals by itself but instead acts as a controllable reflector of signals transmitted and received by other nodes in the system.

FIG. 1 schematically illustrates a communication network 100 in which access points 500a, 500b are configured to provide network access to user equipment (UEs) 600a, 600b. Signals communicated over wireless links 700a, 700b between access point 500a and UE 600a are reflected via a reflective array 400 of a RIS 300. More particularly, the reflective array 400 is composed of antenna arrays, and the signals are reflected according to reflection phases of the antenna elements. The reflection phases are controlled, or set, by a controller 200 provided in the RIS 300. The purpose of the controller 200 is thus to control how incoming signals are steered or simply reflected at the RIS 300. For this purpose, according to published technology, the controller may have a signaling connection (wired or wireless) with a network node, such as a gNB. The gNB then needs to know how to configure the RIS to optimize the end-to-end link using the reflections from the RIS. In order to evaluate different RIS configurations, the gNB may request the controller to facilitate a sweep, or switch, between different configurations of the elements in the RIS whilst an access point 500a transmits or receives signals, such as reference signals, to/from a served UE 600a in the network for analysis of suitable configurations of the elements in the reflective array of the RIS.

Some drawbacks of currently used techniques for configuring the RIS will be summarized next.

Long latency resulting from for the change of settings of the elements at the RIS might prevent beam sweeping at the RIS. The switch between multiple configuration options for trying potential suitable settings of the elements might be time consuming and therefore limit the usage of the RIS for beam sweeping to accomplish useful signal reflections.

It takes time and requires the use of radio resources to perform an analysis of different settings of the elements at the RIS. As an example, consider settings to be used for reflection of uplink signals from served user equipment. Since the evaluation of different settings of the elements at the RIS is performed end-to-end between serving gNB and served user equipment there is e.g., a need at the gNB to allocate separate radio resources for evaluating signals for each served user equipment.

### SUMMARY

An object of embodiments herein is to address the above-disclosed drawbacks of currently used techniques for configuring the RIS.

According to a first aspect there is presented a reconfigurable intelligent surface. The reconfigurable intelligent surface comprises antenna elements provided in a reflective array. Each antenna element has a controllable reflection phase. Only a strict subset of the antenna elements is arranged for obtaining radio measurements. The antenna elements of the strict subset are distributed across the reflective array. The reconfigurable intelligent surface comprises a controller. The controller is configured to evaluate radio signal characteristics of the reflective array from the radio measurements. The controller is configured to control the reflection phases of the antenna elements as a function of the evaluated radio signal characteristics.

According to a second aspect there is presented a method for controlling a reconfigurable intelligent surface according to the first aspects. The method is performed by the controller. The method comprises obtaining radio measurements from the strict subset of the antenna elements. The method comprises evaluating radio signal characteristics at the reflective array from the radio measurements. The method comprises controlling the reflection phases of the antenna elements as a function of the evaluated radio signal characteristics.

According to a third aspect there is presented a controller for controlling a reconfigurable intelligent surface according to the first aspects. The controller comprises processing circuitry. The processing circuitry is configured to cause the controller to obtain radio measurements from the strict subset of the antenna elements. The processing circuitry is configured to cause the controller to evaluate radio signal characteristics at the reflective array from the radio measurements. The processing circuitry is configured to cause the controller to control the reflection phases of the antenna elements as a function of the evaluated radio signal characteristics.

According to a fourth aspect there is presented a controller for controlling a reconfigurable intelligent surface according to the first aspects. The controller comprises an obtain module configured to obtain radio measurements from the strict subset of the antenna elements. The controller comprises an evaluate module configured to evaluate radio signal characteristics at the reflective array from the radio measurements. The controller comprises a control module configured to control the reflection phases of the antenna elements as a function of the evaluated radio signal characteristics.

According to a fifth aspect there is presented a computer program for controlling a reconfigurable intelligent surface according to the first aspects, the computer program comprising computer program code which, when run on a controller, causes the controller to perform a method according to the second aspect.

According to a sixth aspect there is presented a computer program product comprising a computer program according to the fifth aspect and a computer readable storage medium on which the computer program is stored. The computer readable storage medium could be a non-transitory computer readable storage medium.

Advantageously, these aspects resolve the above-disclosed drawbacks of currently used techniques for configuring the RIS.

Advantageously, these aspects yield continuous channel awareness for the full reflective array in multiple angles/directions.

Advantageously, these aspects enable radio measurements only obtained from a small fraction of all the antenna elements to be used when evaluating radio signal characteristics of all antenna elements at the reflective array

Advantageously, by evaluating radio signal characteristics from radio measurements obtained from only a small fraction of all the antenna elements, these aspects enable the RIS to make a quick switch from one configuration to another (in terms of which reflection phases to be applied at the antenna elements) without the need for a dedicated beam sweep to be made.

Advantageously, these aspects enable the RIS to make a quick switch from one configuration to another without the use of dedicated signals.

Advantageously, these aspects enable increased energy efficiency by using already available signals for making the radio measurements.

Advantageously, these aspects enable increased multi-reflection capability of the RIS in case the strict subset of antenna elements are provided with signal amplifying transmit capability. In such case even a relatively small strict subset of antenna elements can be used to implement a reflection of signals in different directions than the remaining antenna elements of the reflective array.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIGS. 2, 3, and 4 schematically illustrate a reflective array according to embodiments;

FIGS. 5 and 6 are flowcharts of methods according to embodiments;

FIG. 7 is a schematic diagram showing functional units of a controller according to an embodiment;

FIG. 8 is a schematic diagram showing functional modules of a controller according to an embodiment; and

FIG. 9 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

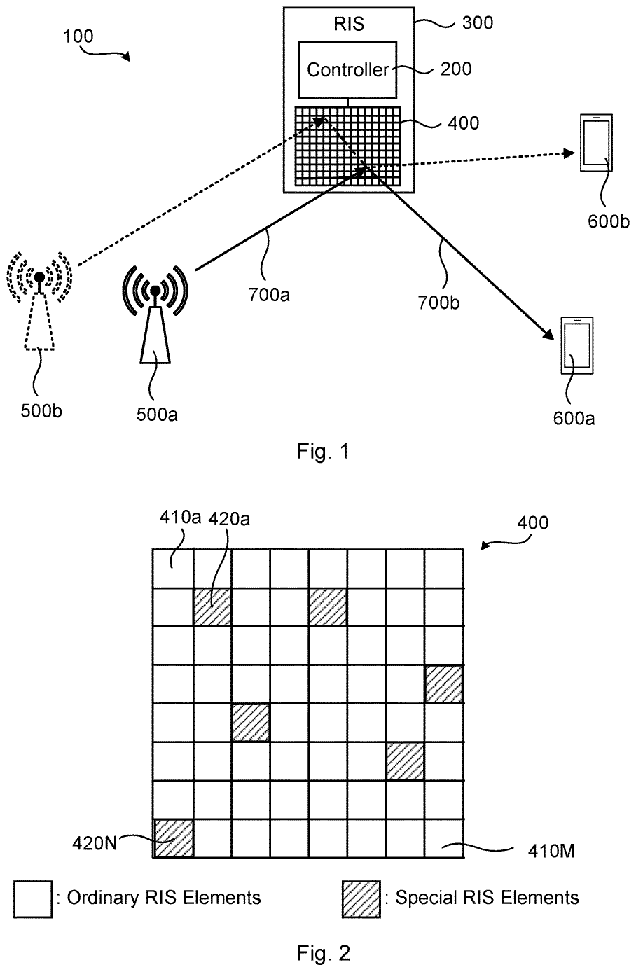

Continued reference will be made to FIG. 1.

Some issues with currently used techniques for configuring a RIS have been disclosed above. Further in this respect, currently used techniques for configuring the RIS might have limited awareness of the radio environment. In further detail, the RIS itself is not configured to analyze radio characteristics and the RIS therefore cannot be used for any self-evaluations of the radio channel. This means that while the RIS is configured for a certain steering/reflection of signals, the RIS has no knowledge about variations in the radio environment surrounding the RIS. In other words, the RIS has access to little or no information pertaining to variations in interference, UE movement, etc.

The embodiments disclosed herein therefore relate to a RIS 300 and techniques for controlling the RIS 300. In order to obtain such techniques there is provided a RIS 300, a controller 200, methods performed by the controller 200, and a computer program product comprising code, for example in the form of a computer program, that when run on the controller 200, causes the controller 200 to perform the methods. According to the herein disclosed embodiments, a subset of the antenna elements, as distributed across the reflective array 400, is utilized to evaluate panel specific radio signal characteristics. The RIS 300 can thereby benefit from an evaluation of the radio channel, as achieved using only a small number of antenna elements of the panel, to evaluate how the rest of the antenna elements should be configured. The subset of the antenna elements therefore acts as sampling points for the entire reflective array. The special elements can be included as a subset of the reflective elements within the RIS. This is different to controlling, or communicating with the RIS, e.g. via the controller on a dedicated control channel over a wired or wireless link.

In particular, the RIS 300 comprises antenna elements 410a:410M. The antenna elements 410a:410M are provided in a reflective array 400. Each antenna element 410a:410M has a controllable reflection phase. Only a strict subset 420a:420N of the antenna elements 410a:410M is arranged for obtaining radio measurements. Such obtaining of radio measurements may as one example be performed by radio signal reception in the RIS via the strict subset 420a:420N. As will be further disclosed below, not all antenna elements 420a:420N in the strict subset, but only a subgroup of those antenna elements 420a:420N, need to be activated at a given point in time.

Only the antenna elements 420a:420N need to be provided with, or operatively connected to, radio receiver chains. In some non-limiting examples, the strict subset 420a:420N of antenna elements is composed of less than 1/10, or less than 1/100, or less than 1/1000, of all the antenna elements 410a:410M. Hence, only a very small proportion (as defined by the strict subset) of the antenna elements are arranged for obtaining radio measurements and need to be provided with, or operatively connected to, radio receiver chains. The strict subset 420a:420N of antenna elements are therefore assumed to be individually controlled separately from the remaining antenna elements of the reflective array. This means that while the RIS 300 is predominantly utilized as a reflector for improving radio transmission characteristics in the end-to-end signaling between access points and UEs using a certain configuration of reflection phases of the antenna elements in the reflective array 400, a subset of the antenna elements in the reflective array 400 is arranged for obtaining radio measurements and need to be provided with, or operatively connected to, radio receiver chains.

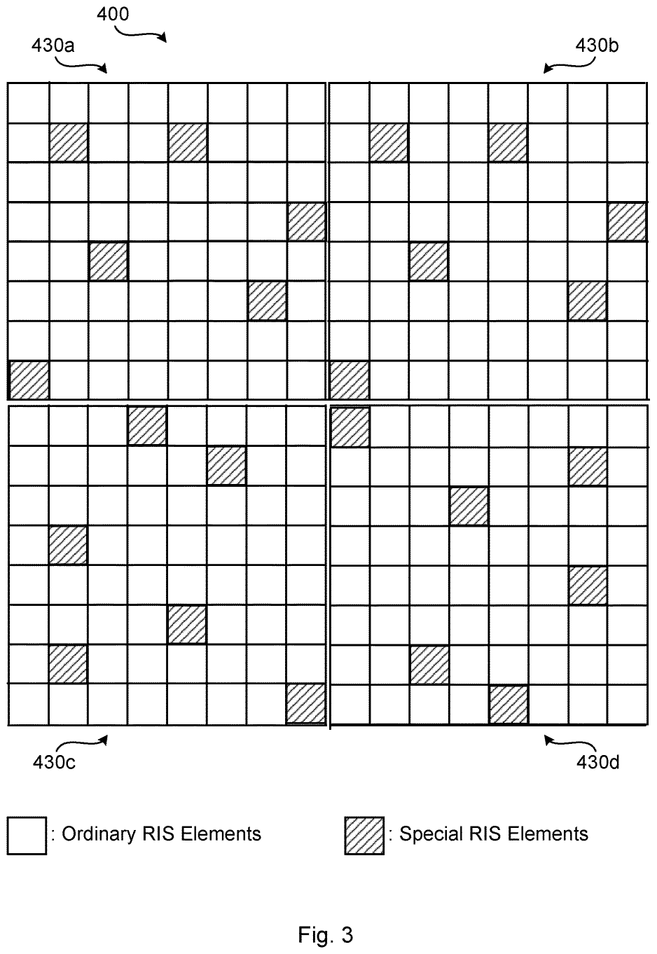

In FIG. 2 is schematically illustrated an embodiment of a reflective array 400 in the form of an 8-by-8 rectangular antenna array, where six of the 64 antenna elements are included in the strict subset. In FIG. 2 (and also in FIG. 3, and 4, which will be referred to below) the antenna elements 420a:420N of the strict subset are distributed across the reflective array 400. In FIG. 2 (and also in FIG. 3, and 4, which will be referred to below) the antenna elements 420a:420N in the strict subset are referred to as special RIS elements.

The RIS 300 further comprises a controller 200. The controller 200 is configured to evaluate radio signal characteristics of the reflective array 400 from the radio measurements. The controller 200 is further configured to control the reflection phases of the antenna elements 410a:410M as a function of the evaluated radio signal characteristics.

The RIS 300 might be provided as a stand-alone entity, or node, as in FIG. 1. However, the RIS 300 might also be provided as part of a network node, or as part of a UE.

Embodiments relating to further details of the RIS 300 will now be disclosed.

The proposed RIS 300 enable panel specific radio signal characteristics to be evaluated using only a subset of the antenna elements. Hence, only the antenna elements of this subset need to be coupled to radio receiver chains, or be configured for more enabling advanced signal processing to be carried out. There can be different examples of such advanced signal processing. In general terms, such advanced capability typically might pertain to capabilities to receive and decode wirelessly received signals, and/or to conduct measurements of the relative phases and amplitudes of the wirelessly received signals. Further details thereof will be disclosed next.

In some aspects, the RIS 300 is, via the subset 420a:420N of antenna elements enabled to perform channel sensing in one or more directions. Hence, some embodiments, the radio measurements pertain to channel sensing in at least one direction. This, in turn, enables the controller 200 to perform radio channel evaluation. The subset 420a:420N of antenna elements can be used to obtain accurate channel state information, which leads to better communication performance. The channel state information for the wireless link between the access point and a UE is commonly obtained at the access point and/or the UE by employing channel estimation algorithms considering time and/or frequency domain properties of the radio channel in which the wireless link is established. At least one part of the signal communicated between the access point and the UE is transmitted via the reflective array within the communication path between the access point and the UE. The channel state estimation as performed by the controller 200 can be regarding as considering the third dimension, i.e., the spatial domain, of the channel state acquisition. With accurate knowledge about the radio channel in one, or both of, the propagation paths involving the RIS 300 together with the reconfigurable reflection characteristics of the RIS 300, the channel state information can be estimated in more details compared to using a RIS 300 without such evaluation capability. In this way, the radio propagation channel between access points and UEs can be estimated in time, frequency, and, via the RIS 300, also in the spatial domain. This additional information can be used to reconfigure the RIS 300 to tailor the communication (e.g., reflect signals in a given, estimated direction or to be focused in an estimated direction) to improve the received signal strength over the end-to-end link between the access point and the UE. This performance increase without the need to add more reference signals to the frame structure. The typical reference signals, which are used at access points and UEs for the purpose of obtaining channel state information are tailored for channel estimation and since multiple receivers can receive a signal, and since the same type of channel estimation can be performed at the controller 200 as at the access points and the UEs, these existing signals can also be used by the controller 200 to perform channel state acquisition in the spatial domain. In one or more examples, this may therefore be used in the system as a regular channel measurement function for this separate path in the end-to-end communication. This means that independent of the uplink or downlink channel estimation and channel quality reporting etc. which may be executed by access points and UEs in the communication system, the controller 200 may perform channel link estimations for the wireless links between the access point and the RIS 300 and between the UE and the RIS 300 to maintain up to date information on how to optimize the antenna elements in the reflective array for performing reflections of signals communicated between the access points and the UEs.

In some aspects, the RIS 300 is, via the subset 420a:420N of antenna elements, enabled to estimate the angle of arrival. In particular, in some embodiments, the radio measurements pertain to angle-of-arrival of signals received via the strict subset 420a:420N of the antenna elements 410a:410M.

In some aspects, the RIS 300 is configured to demodulate and decode transmitted information within signals received via the subset 420a:420N of antenna elements. In particular, in some embodiments, the controller 200 is configured to demodulate and decode information within signals received via the strict subset 420a:420N of the antenna elements 410a:410M.

In some aspects, the RIS 300 is configured to transmit signals via the subset 420a:420N of antenna elements. In particular, in some embodiments, the strict subset 420a:420N of the antenna elements 410a:410M is arranged for power amplified signal transmission. This could enhance the general signal strength characteristics of the RIS 300.

In general terms, the controller 200 is configured to evaluate radio signal characteristics at the reflective array 400 from the radio measurements obtained from the antenna elements 420a:420N in the strict subset of the antenna elements. There could be different purposes for such an evaluation. Different aspects relating thereto will be disclosed next.

In some aspects, one purpose for the controller 200 to obtain the measurements is for the controller 200 to receive and evaluate signals received from different directions than what the other antenna elements are configured for. Hence, in some embodiments, the radio measurements pertain to reception of reference signals in at least one other direction than as defined by the controllable reflection phases.

In some aspects, in order for the controller 200 to receive and evaluate signals received from, say, UEs, the controller 200 is informed of in what time and frequency pattern one or more of UEs are expected to transmit signals. Hence, in some embodiments, the controller 200 is configured to obtain information of in what time and frequency resource the reference signals are to be transmitted. In some non-limiting examples, each time and frequency resource is defined by one or more resource elements in a time/frequency grid. The information might be obtained by the controller 200 from the network, for example via a dedicated control channel via the access point 500a, or by the controller 200 being hard-coded with the information, or by the controller 200 accessing the information from a database. The controller 200 might be configured to measure on signals which are already expected to be transmitted in the network. As example, for evaluation of transmissions from access points, the controller 200 might evaluate signals which are typically repeatedly transmitted by access points. In a fifth generation (5G) New Radio (NR) system, an access point is expected to transmit synchronization signal bursts (SSBs) for UEs to be aware of access point (cell) existence, timing and main system information. A controller 200 of a RIS 300 as herein disclosed may use such SSB transmissions to sample the radio channel and to receive cell specific time synchronization information which may be useful for the controller 200 to be able to evaluate other signaling, such as UE transmissions.

In some aspects, one purpose for the controller 200 to obtain the measurements is for the RIS 300 to maintain uplink awareness of suitable controllable reflection phases that might be applied at the antenna elements for reflecting signals between access points and UEs. In particular, in some embodiments, the reference signals are received from an access point 500 a or a UE 600 b, and the strict subset 420a:420N of the antenna elements 410a:410M is, by the controller 200, controlled to track movement of the access point 500 a or the UE 600 b. In this way, the strict subset 420a:420N of the antenna elements can be configured to receives signals from other directions than the remaining antenna elements of the reflective array. The controller 200 might then be configured to evaluate suitable configurations of the antenna elements so as for the RIS 300 to reflect signals to/from the tracked access point 500a and/or UE 600b. Therefore, in some embodiments, the radio signal characteristics are evaluated by the controller 200 to control the reflection phases of the antenna elements 410a:410M for reflection from and/or towards the access point 500a or the UE 600b.

In some aspects, one purpose for the controller 200 to obtain the measurements is for the RIS 300 to monitor the possible presence of other access points 500b. In particular, in some embodiments, the controllable reflection phases of the antenna elements 410a:410M are controlled for reflection from and/or towards a first access point 500a, where the reference signals are received from a second access point 500b. The controller 200 might then be configured to evaluate suitable configurations of the antenna elements so as for the RIS 300 to reflect signals to/from this second access point 500b. Therefore, in some embodiments, the radio signal characteristics are evaluated by the controller 200 to control the reflection phases of the antenna elements 410a:410M for reflection from and/or towards the second access point 500b. The RIS 300 might thereby be selectively used to over time (i.e., in a time division manner) reflect signals to/from different access points. At time periods when the antenna elements are configured for reflecting signals to/from the first access point 500a, the subset of antenna elements can be used to monitor signals from the second access point 500b, and vice versa. In general terms, the strict subset 420a:420N can in one or more examples be configured in a different configuration setting as compared to the other antenna elements in the antenna array. This different configuration setting can be used to form a signal monitoring in a direction for the strict subset 420a:420N being different than the reflection direction of other antenna elements of the antenna array. As above, such signal monitoring may involve radio measurements on reference signals, such as SSBs.

One technical benefit for both preceding aspects is that the measurements obtained from signals received by the strict subset 420a:420N of the antenna elements 410a:410M, by the controller 200 can be used to estimate the location of further entities in the network so that signals can, by the RIS 300, be reflected to/from these entities.

The strict subset 420a:420N of the antenna elements acts as sample points within the reflective array. The distribution of the strict subset 420a:420N of the antenna elements as sample points within the reflective array enables the controller 200 to estimate how to configure the rest of the antenna elements. In other words, the controller 200 might be configured to store and process information on how the antenna elements can be configured to tailor the configurations of the reflective array other than the currently used. This could be used to prepare the the RIS 300 for different configurations of the reflective array.

In some aspects, knowledge of the locations of the strict subset 420a:420N of the antenna elements 410a:410M within the reflective array is used to evaluate array specific characteristics which may be used to configure the rest of the antenna elements in the reflective array. For example, the radio measurements might pertain to information of the relative received signal phases between antenna elements in the strict subset of antenna elements. That is, in some embodiments, the radio measurements pertain to relative received signal phases between pairs of antenna elements 420a:420N in the strict subset of the antenna elements. The radio channel properties might vary depending on the physical location of each antenna element in the reflective array. By using the knowledge of the position of each antenna element in the strict subset and detecting variations in the radio channel, such as amplitude and phase differences, the expected channel conditions can be calculated also for antenna elements at other locations within the reflective array, e.g., by mathematical interpolation and/or extrapolation. In other words, radio measurements obtained from the strict subset of antenna elements can be used to estimate the expected radio signal conditions for the remaining antenna elements within the reflective array.

A phase interpolation function can be calculated for all the antenna elements in the reflective array based on the radio signal characteristics as evaluated from the from the radio measurements. A linear gradient technique can be used as interpolation function for the RIS 300 to act as a well-adjusted flat mirror for signals that are reflected by the RIS 300. Likewise, a non-linear gradient technique can be used as interpolation function for the RIS 300 to act like a focusing non-flat mirror for signals that are reflected by the RIS 300. Hence, in some embodiments, the radio signal characteristics are evaluated according to a linear or a non-linear gradient interpolation function operating on the relative received signal phases. The gradient function, for a given antenna element, takes as input the two coordinates that describe the location of the given antenna element in the antenna array. Without using radio measurements from the strict subset 420a:420N of the antenna elements, finding the settings would be highly time consuming since focusing the signal has more degrees of freedom, where the phase settings of the antenna elements depend not only on directions but also on distances, thus increasing the sweep size.

In general terms, the measured phase for each antenna element will be in a 360-degree range, for instance between 0 and 360 degrees, or between −180 and +180 degrees. The interpolation function, however, might not have such limits, and phase values of the interpolation function might therefore be outside the interval of the measured phase. When comparing the values of the interpolation function to the measured values, as given by the radio measurements, of the antenna elements, an operation where an integer number of 360 degrees is added or subtracted to the function value might therefore be performed so that the distance to the measured value is minimized. This is then repeated for all antenna elements where the phase is to be compared.

There can be different ways in which the antenna elements of the strict subset 420a:420N are irregularly distributed (among the antenna elements 410a:410M) across the reflective array 400. In general terms, the antenna elements of the strict subset 420a:420N can be either arranged in a specific pattern or be irregularly distributed. In some examples, the antenna elements of the strict subset 420a:420N of the antenna elements are irregularly distributed across the reflective array 400. With a irregular pattern it is possible to avoid some detrimental effects on the beamforming due to boundary effects of the reflective array itself. One benefit of such an arrangement is that the sampling of the properties of the antenna array becomes irregular and hence less sensitive to aliasing effects that may occur in regular sparse sampling. Another benefit of such an arrangement is that it would reduce effects of potential systematic differences in the antenna element performance, e.g. from production. If there are any regular, systematic performance variances in the antenna elements, a random selection of sample points for radio measurements allows to reduce such effects. In some examples, the reflective array 400 is composed of sub-panels 430a:430d, and the antenna elements of the strict subset 420a:420N of the antenna elements are irregularly distributed per each of the sub-panels 430a:430d and with a repetitive pattern across all the sub-panels 430a:430d. The sub-panels 430a:430d might, for example, be mounted such that there is a 0, 90, 180 and/or 270 degrees rotation (in a pseudo-random pattern) between adjacent sub-panels. One benefit of using a construction of many sub-panels instead of one single large panel is a less complicated production process. In FIG. 3 is schematically illustrated an embodiment of a reflective array 400 in the form of a 16-by-16 rectangular antenna array composed of four sub-panels 430a, 430b, 430c, 430d. Sub-panels 430a and 430b have been mounted with same orientation. Sub-panel 430c has been mounted rotated 90 degrees anti-clockwise with respect to sub-panel 430a. Sub-panel 430d has been mounted rotated 180 degrees with respect to sub-panel 430c.

In some aspects, not all the antenna elements of the strict subset 420a:420N are activated each time radio measurements are to be obtained. Rather, in some aspects only a subset of these antenna elements are selected and activated for radio measurements. That is, in some embodiments, the controller 200 is configured to, at a time, activate only a subgroup of antenna elements composed of less than all the antenna elements of the strict subset 420a:420N of the antenna elements for obtaining the radio measurements.

In some aspects, there at least two such subgroups. This enables a selection to be made between different subgroups of antenna elements to be activated each time radio measurements are to be obtained. Hence, in some examples, the strict subset of the antenna elements is divided into at least a first subgroup of antenna elements and a second subgroup of antenna elements, and the controller 200 is configured to, at a time, activate only one of the subgroups of antenna elements for obtaining the radio measurements. The first subgroup and the second subgroup may either be distinct from each other or be partly (but not fully) overlapping with each other. In FIG. 4 is schematically illustrated an embodiment of a reflective array 400 in the form of an 8-by-8 rectangular antenna array, where six of the 64 antenna elements are included in the strict subset. Further, the antenna elements 420a:420N of the strict subset are divided into two subgroups, where one subgroup contains activated special antenna elements whereas the other subgroup contains disabled special antenna elements, depending on whether the reflective array 400 is operated in “Mode 1” or “Mode 2”. Which of the special antenna elements that are activated and disabled might change over time.

In some aspects, there are different number of antenna elements in different subgroups. That is, in some embodiments, the first subgroup of antenna elements and the second subgroup of antenna elements include differently many antenna elements 410a:410M.

Three could be different factors, or parameters, taken into account by the controller 200 when deciding which subgroup of antenna elements to activate. In some non-limiting examples, which subgroup of antenna elements to activate depends on any, or any combination of: the radio environment characteristics of the RIS 300, the size of the reflective array 400, the number of antenna elements 410a:410M provided in the reflective array 400, the characteristics of any radio communication link between an access point and a UE as reflected by the antenna elements 410a:410M.

Further, there could be different factors, or parameters, taken into account by the controller 200 when deciding whether to activate any of the antenna elements of the strict subset 420a:420N of antenna elements or not. In some non-limiting examples, the more stationary the radio environment is, the less often the antenna elements of the strict subset 420a:420N need to be activated. In this way a subgroup can be activated according to some duty cycle that depends on channel coherency time, etc. If more radio activity is detected (or more UEs have their signals reflected by the RIS 300), then more antenna elements could be activated. One benefit of this is that there can be a more dynamic balance, or trade off, in-between the ratio related to the number of antenna elements in the strict subset versus the total number of antenna elements in the reflective array. Since the number of active antenna elements in the strict subset, and the pattern of such active antenna elements, can be changed depending on radio propagation conditions, a better performance can be achieved.

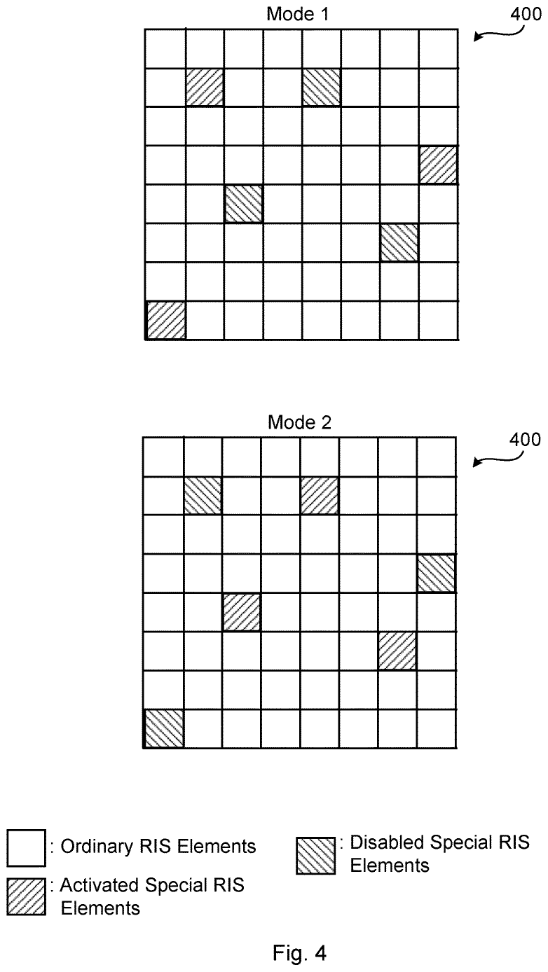

Reference is next made to the flowchart of FIG. 5 for embodiments of methods for controlling a RIS 300 according to any of the above disclosed embodiments, aspects, and examples. The methods are performed by the controller 200. The methods are advantageously provided as computer programs 920.

S102: The controller 200 obtains radio measurements from the antenna elements 420a:420N in the strict subset of the antenna elements.

S104: The controller 200 evaluates radio signal characteristics at the reflective array 400 from the radio measurements.

S106: The controller 200 controls the reflection phases of the antenna elements 410a:410M as a function of the evaluated radio signal characteristics.

Embodiments relating to further details of controlling a RIS 300 as performed by the controller 200 will now be disclosed.

The embodiments, aspects, and examples disclosed above with reference to the RIS 300 apply equally to the methods performed by the controller 200.

In some embodiments, the controller 200 demodulates and decodes information within signals received via the strict subset 420a:420N of the antenna elements 410a:420M.

In some embodiments, the controller 200 obtains information of in what time and frequency resource the reference signals are to be transmitted.

In some embodiments, the reference signals are received from an access point 500a or a UE 600b, and the controller 200 controls the strict subset 420a:420N of the antenna elements 410a:420M to track movement of the access point 500a or the UE 600b.

In some embodiments, the controller 200, at a time, activates only a subgroup of antenna elements composed of less than all the antenna elements of the strict subset of the antenna elements for obtaining the radio measurements.

In some embodiments, the strict subset of the antenna elements is divided into at least a first subgroup of antenna elements and a second subgroup of antenna elements and the controller 200, at a time, activates only one of the subgroups of antenna elements for obtaining the radio measurements.

One particular embodiment for controlling a RIS 300 will be disclosed next with reference to the flowchart of FIG. 6.

S201: The controller 200 is triggered to control the reflection phases of the antenna elements 410a:410M.

S202: The controller 200 selects operating mode. Step S203 is entered in case radio measurements obtained from the antenna elements 420a:420N in the strict subset of the antenna elements are to be used by the controller 200 to control the reflection phases of the antenna elements 410a:410M. Otherwise step S206 is entered. Step S203 can be entered when reference signals or synchronization signals have been scheduled for transmission in the downlink and/or uplink.

S203: The controller 200 selects which elements in the strict subset of the antenna elements to be activated for obtaining radio measurements.

S204: Radio signals are received at the strict subset of the antenna elements. The radio signals might be reference signals or synchronization signals transmitted in the downlink and/or uplink.

S205: The controller 200 obtains the radio measurements from the antenna elements 420a:420N in the strict subset of the antenna elements. The controller 200 evaluates radio signal characteristics at the reflective array 400 from the radio measurements.

S206: The strict subset of the antenna elements is not activated for obtaining radio measurements but can instead be used to reflect signals between access points and UEs.

S207: The controller 200 controls the reflection phases of the antenna elements 410a:410M by calculating values of the reflection phases to be applied at the antenna elements. In case step S203 was entered, the reflection phases of the antenna elements 410a:410M is controlled as a function of the evaluated radio signal characteristics.

S208: Values of the reflection phases as determined in step S207 are applied at the antenna elements.

S209: The antenna elements can be used to reflect signals between access points and UEs according to the applied values of the reflection phases.

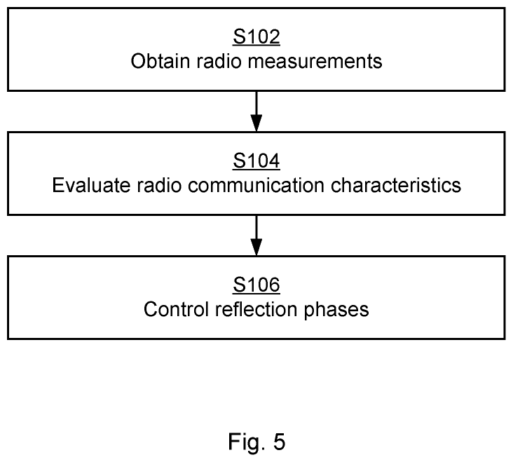

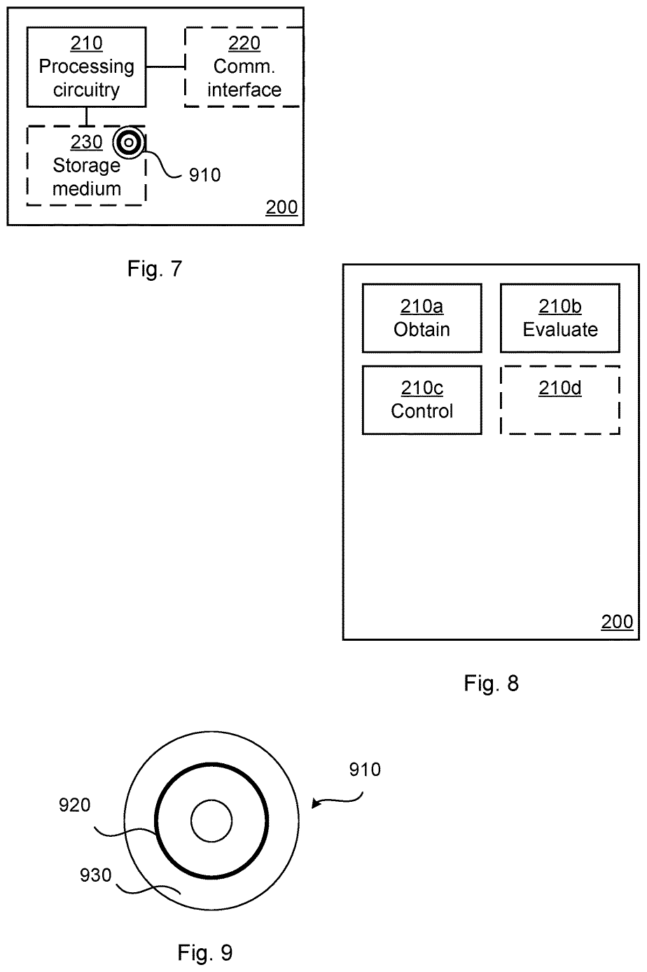

FIG. 7 schematically illustrates, in terms of a number of functional units, the components of a controller 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 910 (as in FIG. 9), e.g., in the form of a storage medium 230. The processing circuitry 210 may further be provided as at least one application specific integrated circuit (ASIC), or field programmable gate array (FPGA).

Particularly, the processing circuitry 210 is configured to cause the controller 200 to perform a set of operations, or steps, as disclosed above. For example, the storage medium 230 may store the set of operations, and the processing circuitry 210 may be configured to retrieve the set of operations from the storage medium 230 to cause the controller 200 to perform the set of operations. The set of operations may be provided as a set of executable instructions.

Thus, the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The controller 200 may further comprise a communications interface 220 at least configured for communications with other components, or entities, within the RIS 300, as well as for communication with one or more access point 500a, 500b. As such the communications interface 220 may comprise one or more transmitters and receivers, comprising analogue and digital components. The processing circuitry 210 controls the general operation of the controller 200 e.g. by sending data and control signals to the communications interface 220 and the storage medium 230, by receiving data and reports from the communications interface 220, and by retrieving data and instructions from the storage medium 230. Other components, as well as the related functionality, of the controller 200 are omitted in order not to obscure the concepts presented herein.

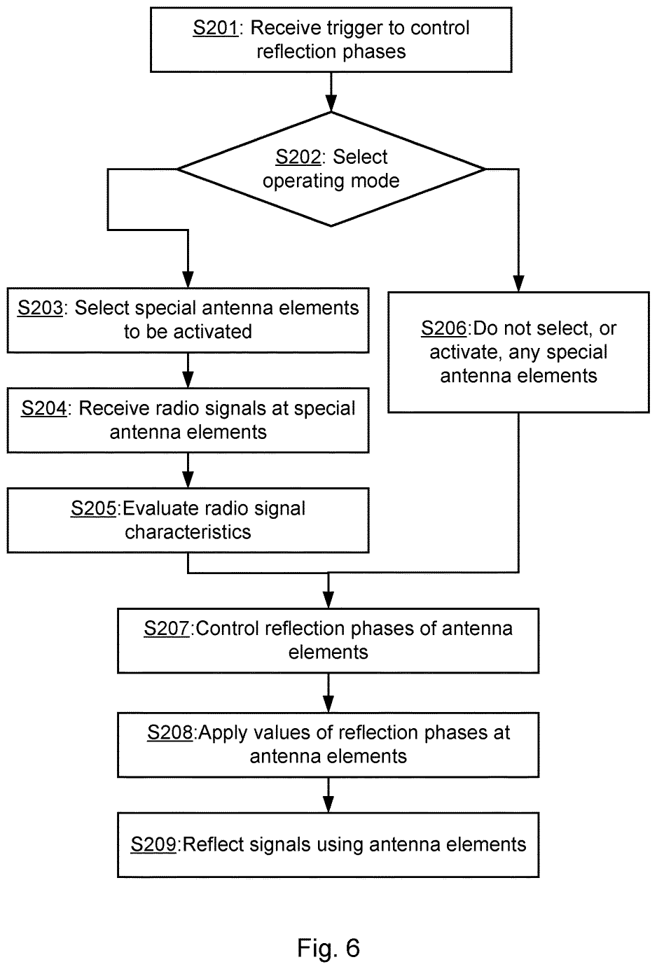

FIG. 8 schematically illustrates, in terms of a number of functional modules, the components of a controller 200 according to an embodiment. The controller 200 of FIG. 8 comprises a number of functional modules; an obtain module 210a configured to perform step S102, an evaluate module 210b configured to perform step S104, and a control module 210c configured to perform step S106. The controller 200 of FIG. 8 may further comprise a number of optional functional modules, as represented by functional module 210d. In general terms, each functional module 210a:210d may in one embodiment be implemented only in hardware and in another embodiment with the help of software, i.e., the latter embodiment having computer program instructions stored on the storage medium 230 which when run on the processing circuitry makes the controller 200 perform the corresponding steps mentioned above in conjunction with FIG. 8. It should also be mentioned that even though the modules correspond to parts of a computer program, they do not need to be separate modules therein, but the way in which they are implemented in software is dependent on the programming language used. Preferably, one or more or all functional modules 210a:210d may be implemented by the processing circuitry 210, possibly in cooperation with the communications interface 220 and/or the storage medium 230. The processing circuitry 210 may thus be configured to from the storage medium 230 fetch instructions as provided by a functional module 210a:210d and to execute these instructions, thereby performing any steps as disclosed herein. The controller 200 may be provided as a standalone device or as a part of at least one further device. For example, as disclosed above the controller 200 might be provided in the reconfigurable intelligent surface 300.

FIG. 9 shows one example of a computer program product 910 comprising computer readable storage medium 930. On this computer readable storage medium 930, a computer program 920 can be stored, which computer program 920 can cause the processing circuitry 210 and thereto operatively coupled entities and devices, such as the communications interface 220 and the storage medium 230, to execute methods according to embodiments described herein. The computer program 920 and/or computer program product 910 may thus provide means for performing any steps as herein disclosed.

In the example of FIG. 9, the computer program product 910 is illustrated as an optical disc, such as a CD (compact disc) or a DVD (digital versatile disc) or a Blu-Ray disc. The computer program product 910 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 920 is here schematically shown as a track on the depicted optical disk, the computer program 920 can be stored in any way which is suitable for the computer program product 910.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A reconfigurable intelligent surface, comprising:
antenna elements provided in a reflective array, each antenna element having a controllable reflection phase, only a strict subset of the antenna elements being arranged for obtaining radio measurements and being distributed across the reflective array; and
a controller, the controller being configured to evaluate radio signal characteristics of the reflective array from the radio measurements, and to control the reflection phases of the antenna elements as a function of the evaluated radio signal characteristics.

2. The reconfigurable intelligent surface according to claim 1, wherein the radio measurements pertain to channel sensing in at least one direction.

3. The reconfigurable intelligent surface according to claim 1, wherein the radio measurements pertain to angle-of-arrival of signals received via the strict subset of the antenna elements.

4. The reconfigurable intelligent surface according to claim 1, wherein the controller is configured to demodulate and decode information within signals received via the strict subset of the antenna elements.

5. The reconfigurable intelligent surface according to claim 1, wherein the strict subset of the antenna elements is arranged for power amplified signal transmission.

6. The reconfigurable intelligent surface according to claim 1, wherein the radio measurements pertain to reception of reference signals in at least one other direction than as defined by the controllable reflection phases.

7. The reconfigurable intelligent surface according to claim 6, wherein the controller is configured to obtain information of in what time and frequency resource the reference signals are to be transmitted.

8. The reconfigurable intelligent surface according to claim 6, wherein the reference signals are received from an access point or a user equipment, and wherein the strict subset of the antenna elements. is, by the controller, controlled to track movement of the access point or the user equipment.

9. The reconfigurable intelligent surface according to claim 8, wherein the radio signal characteristics are evaluated by the controller to control the reflection phases of the antenna elements for reflection from and/or towards the access point or the user equipment.

10. The reconfigurable intelligent surface according to claim 6, wherein the controllable reflection phases of the antenna elements are controlled for reflection from and/or towards a first access point and wherein the reference signals are received from a second access point.

11. The reconfigurable intelligent surface according to claim 10, wherein the radio signal characteristics are evaluated by the controller to control the reflection phases of the antenna elements for reflection one or both from and towards the second access point.

12. The reconfigurable intelligent surface according to claim 1, wherein the radio measurements pertain to relative received signal phases between pairs of antenna elements in the strict subset of the antenna elements.

13. The reconfigurable intelligent surface according to claim 12, wherein the radio signal characteristics are evaluated according to a linear or a non-linear gradient interpolation function operating on the relative received signal phases.

14. The reconfigurable intelligent surface according to claim 1, wherein the antenna elements of the strict subset of the antenna elements are irregularly distributed across the reflective array.

15. The reconfigurable intelligent surface according to claim 1, wherein the reflective array has sub-panels and wherein the antenna elements of the strict subset of the antenna elements are irregularly distributed per each of the sub-panels and with a repetitive pattern across all the sub-panels.

16. The reconfigurable intelligent surface according to claim 1, wherein the controller is configured to, at a time, activate only a subgroup of antenna elements composed of less than all the antenna elements of the strict subset of the antenna elements for obtaining the radio measurements.

17. The reconfigurable intelligent surface according to claim 1, wherein the strict subset of the antenna elements is divided into at least a first subgroup of antenna elements and a second subgroup of antenna elements, and wherein the controller is configured to, at a time, activate only one of the subgroups of antenna elements for obtaining the radio measurements.

18. (canceled)

19. The reconfigurable intelligent surface according to claim 16, wherein which subgroup of antenna elements to activate depends on at least one of:
radio environment characteristics of the reconfigurable intelligent surface;
size of the reflective array number of antenna elements provided in the reflective array; and
characteristics of a radio communication link between an access point and a user equipment as reflected by the antenna elements.

20. (canceled)

21. A method for controlling a reconfigurable intelligent surface, the reconfigurable intelligent surface comprising a controller and antenna elements provided in a reflective array, each antenna element having a controllable reflection phase, only a strict subset of the antenna elements being arranged for obtaining radio measurements and being distributed across the reflective array, the method being performed by the controller, the method comprising:
obtaining radio measurements from the strict subset of the antenna elements;
evaluating radio signal characteristics at the reflective array from the radio measurements; and
controlling the reflection phases of the antenna elements as a function of the evaluated radio signal characteristics.

22. A controller for controlling a reconfigurable intelligent surface, the reconfigurable intelligent surface having antenna elements provided in a reflective array, each antenna element having a controllable reflection phase, only a strict subset of the antenna elements being arranged for obtaining radio measurements and being distributed across the reflective array, the controller comprising processing circuitry, the processing circuitry being configured to cause the controller to:
obtain radio measurements from the strict subset of the antenna elements;
evaluate radio signal characteristics at the reflective array from the radio measurements; and
control the reflection phases of the antenna elements as a function of the evaluated radio signal characteristics.

23.-25. (canceled).
